(19) United States
(12) Patent Application Publication
(10) Pub. No.: US 2013/0153682 A1
(43) Pub. Date: Jun. 20, 2013

(54) ROTATING NOZZLE WITH SPEED REDUCTION FEATURES

(71) Applicants: Randy Dixon, Billings, MT (US); Jeff Bendio, Spokane Valley, WA (US); Brett Howell, Spokane Valley, WA (US)

(72) Inventors: Randy Dixon, Billings, MT (US); Jeff Bendio, Spokane Valley, WA (US); Brett Howell, Spokane Valley, WA (US)

(21) Appl. No.: 13/632,748

(22) Filed: Oct. 1, 2012

Related U.S. Application Data
(60) Provisional application No. 61/541,872, filed on Sep. 30, 2011.

(51) Int. Cl. B05B 3/00

(52) U.S. Cl. CPC B05B 3/003
USPC 239/227

(57) ABSTRACT

A rotational nozzle for distributing fluid is provided. The rotational nozzle is provided to fit within confined volumes, such as storage tanks and provide a broad spray pattern or area of coverage. Braking means for selectively adjusting rotational characteristics of a nozzle head are provided.

The present application claims the benefit of priority from U.S. Provisional Patent Application No. 61/541,872, filed Sep. 30, 2011, the entire disclosure of which is hereby incorporated by reference in its entirety.

### FIELD OF THE INVENTION

The present invention relates generally to nozzles. More specifically, the present invention relates to rotary nozzles adapted to rotate or vary a spray direction based on a pressure applied to the nozzle.

### BACKGROUND

Vessels, such as tanks, are frequently cleaned by inserting a cleaning machine, which is supplied with heated, pressurized cleaning fluid, through an access port in the vessel. The cleaning machine ejects the cleaning fluid as a high velocity jet that scours the inside walls of the tank so as to effect a cleaning action. In order to obtain as wide a coverage as possible, such cleaning apparatus frequently employ rotating nozzles that sweep around as they eject the cleaning fluid. In such apparatus, the rotation of the nozzles may be driven by a gear train that is driven by the incoming flow of cleaning fluid via an impeller connected to the drive shaft for the gear train. Consequently, such apparatus are sometimes referred to as fluid powered, gear driven tank cleaning machines.

Examples of fluid powered, gear driven tank cleaning machines are described in U.S. Pat. No. 3,637,138 to Rucker, U.S. Pat. No. 5,012,976 to Loberg, U.S. Pat. No. 5,954,271 to Minh et al., and U.S. Pat. No. 6,123,271 to Delaney et al., all of which are hereby incorporated by reference in their entireties.

In order to enable the impeller to operate at an efficient speed without causing the nozzles to spin too quickly, which can result in the production of a mist rather than a strong jet, the gear trains of fluid powered, gear driven tank cleaning machines must be capable of high speed reduction. In devices of the prior art, high speed reduction is achieved by means of a number of successive stages of spur and pinion gears. In each stage, a small input pinion gear turns a large output spur gear, thereby causing an incremental speed reduction. The output spur gear of that stage is connected to a small input pinon gear of the next stage, and so on. Unfortunately, this approach results in a relatively large gear train. Consequently, such machines cannot be used in some applications, such as small tanks, which feature relatively small entry ports.

Various known devices, however, fail to provide for various novel features of the present invention, including, for example, speed reducing features and novel gear arrangements.

### SUMMARY OF THE INVENTION

Accordingly, the present invention contemplates a novel system and nozzle device comprising a nozzle head adapted to rotate under a fluid pressure, wherein the nozzle comprise threaded features for adjusting an amount of resistance on rotational features of the nozzle. The present invention further contemplates a beveled gear system comprising two mating gears wherein the gears comprise a disparate number of teeth for achieving an eccentric spray pattern of the nozzle.

The Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The following references related to vessel cleaning devices and rotating nozzles are hereby incorporated by reference in their entireties: U.S. Pat. No. 5,823,435 to Morgan et al., U.S. Pat. No. 6,123,271 to Delaney et al., U.S. Pat. No. 6,561,199 to Gleeson et al., U.S. Pat. No. 7,063,274 to Feller et al., and U.S. Patent Application Pub. No. 2008/0142042 to Bramsen.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as, in the attached drawings and the detailed description of the invention and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1 is a front perspective view of a rotating nozzle of one embodiment of the present disclosure, with various features being transparent for the purposes of illustration;

FIG. 2 is a front elevation view of a rotating nozzle of one embodiment of the present disclosure, with various features being transparent for the purposes of illustration;

FIG. 3 is a front perspective view of a rotating nozzle of one embodiment of the present disclosure;

FIG. 4 is a cross-sectional elevation view of a rotating nozzle of one embodiment of the present disclosure.

### DETAILED DESCRIPTION

The present invention has significant benefits across a broad spectrum of endeavors. It is the applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment of the method that illustrates the best mode now contemplated for putting the invention into practice is described herein by, and with reference to, the annexed drawings that form a part of the specification. The exemplary method is described in detail without attempting to describe all of the various forms and modifications in which the invention might be embodied. As such, the embodiments described herein are illustrative, and as will become apparent to those skilled in the arts, can be modified in numerous ways within the scope and spirit of the invention.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

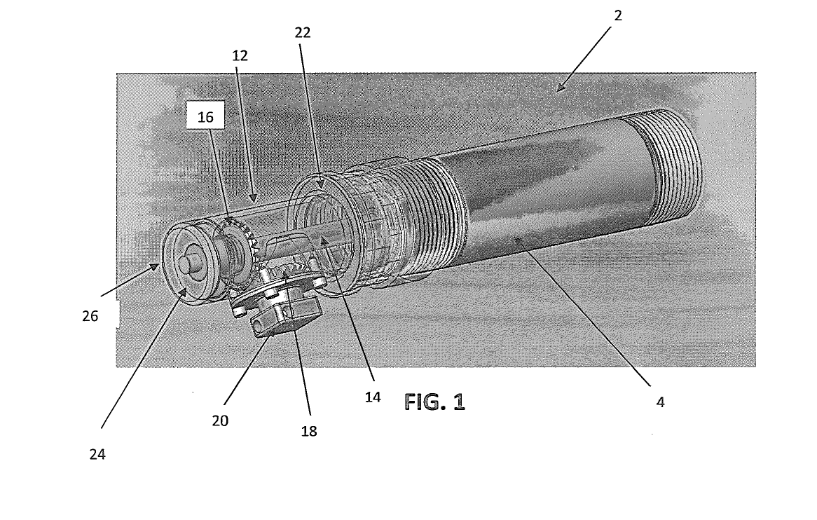

Referring now to FIGS. 1-4, a rotary spray nozzle according to a preferred embodiment is shown. It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiment(s) illustrated in the drawings.

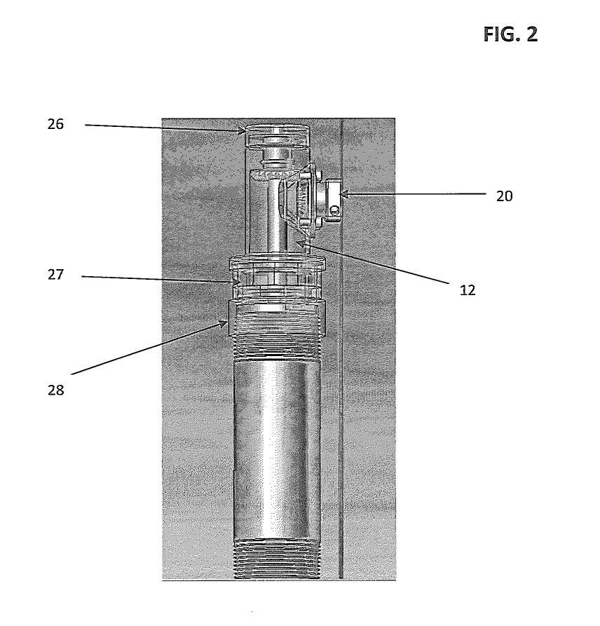

As shown in FIG. 1, a rotary spray nozzle 2 is provided that comprises an inlet portion 4 for receiving a 1.5″ inlet pipe, for example. The inlet portion 4 is preferably threaded on both ends. The inlet portion 4 provides a conduit for transmitting fluid to a rotating outlet 20, in addition to other components. For the purposes of illustration, portions of the nozzle 2 of FIGS. 1-2 are depicted as transparent. Transparent members reveal, for example, the internal features of a rotating conduit 12 disposed within the nozzle 2 and interconnected beveled gear system.

In a preferred embodiment, gears 16, 18 are provided. The gears 16, 18 comprise a disparate number of teeth in order to provide an eccentric rotation of the rotating outlet 20 (at least with respect to the rotating housing 12) and thereby achieve a variable spray pattern desirable for cleaning purposes. For example, a beveled gear disposed in the shaft 14 comprises one or more additional gear teeth as compared with the adjacent gear, or vice-versa. Differing of the number of teeth (effectively diameter) on each gear allows mechanical advantage to be changed. By increasing or decreasing the ratio of teeth between the drive and driven gears, one may change the ratio of rotations between the two, meaning that the rotational drive and torque of the second gear can be changed in relation to the first, with speed increasing and torque decreasing, or speed decreasing and torque increasing. Although beveled gears 16, 18 are depicted in FIG. 1 as being disposed internally to various nozzle components, it will be expressly recognized that the exact arrangement and location of the beveled gears is not critical. Indeed, in an alternative embodiment, beveled gears are disposed external to various nozzle features and/or fluid flow pathways.

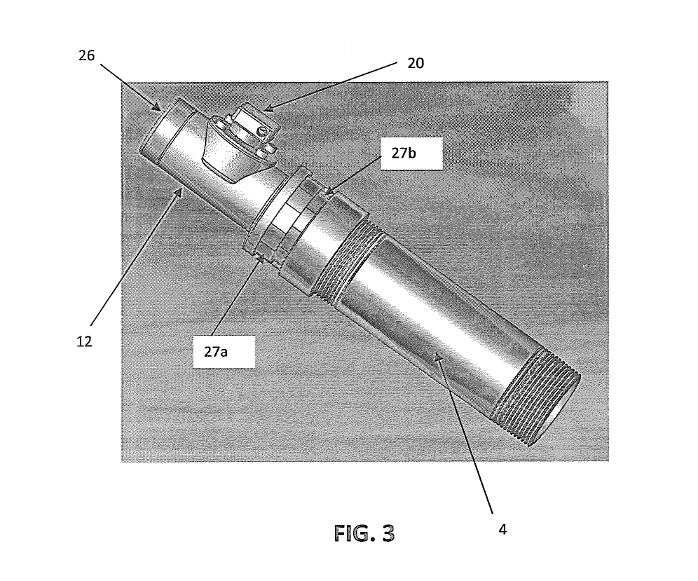

As shown in more detail in FIG. 3, a nozzle of the present disclosure comprises a rotating housing element 12 upon which an outlet 20 is disposed. The rotating element 12 is disposed or sandwiched between fixed portions of the nozzle, such as a conduit 28 and an end cap 26. Referring now to FIGS. 1-3, exit flow of fluid from the rotating outlet 20 will rotate an internally-disposed outlet gear (18 in FIG. 1). Outlet gear 18 interacts with a stationary gear 16 secured to a shaft 14 and in turn secured to an end cap 26. Thus, fluid flow from the rotating outlet 20 causes the outlet gear 18 to “walk” along stationary gear 16, thereby rotating the rotating conduit 12 about a first axis while the outlet 20 rotates about a second axis, the first and second axis disposed generally perpendicular to one another. It will be recognized, therefore, that when pressurized fluid is transmitted through the nozzle 2, forces from the pressurized fluid will cause rotation of the rotating outlet 20 about its primary axis as well as rotation of the rotating conduit about a longitudinal axis of the nozzle 2, thereby affecting an approximately 360 degree spray pattern.

One of skill in the art will recognize that as pressurized fluid travels through a central portion of the nozzle and is expelled from the rotating outlet 20, the exit flow of the fluid will impart a force upon the outlet 20, causing the outlet 20 to rotate unless an appropriate opposing force is applied. Where rotary nozzles are allowed to rotate in a generally unrestricted manner, excessive rotation can occur, further resulting in the exhaust or flow from the nozzle comprising a “mist” as opposed to a concentrated flow desirable to clean surfaces, for example. As shown in FIGS. 1-2, fluid expelled from a rotating outlet 20 will cause rotation of the outlet 20, associated outlet gear 18, and rotating conduit 12.

In various embodiments, nozzles of the present invention comprise braking or locking features whereby selective rotation of various components serves to slow or limit rotation of the rotating outlet and corresponding features. For example, locking or adjustment members 27 may be tightened with respect to various nozzle components, creating increased frictional forces on, for example, one or more brake pads 22, 24. As previously discussed, the rotating conduit is rotatable with respect to fixed nozzle components. One or more brake pad features 22, 24 are provided in preferred embodiments of the present disclosure. Such pads may be comprised of nylon, for example, or various similar materials suitable for accommodating a frictional load. In various embodiments, replacement of the brake pads is facilitated by simple disassembly of the nozzle. In order to regulate or limit rotation of the rotating conduit 12 and interconnected rotating outlet 20, an increase or decrease in pressure may be applied to rotating brake pads 22, 24 by tightening nozzle components. For example, where it desirable to limit rotational speed, lock nuts 27 or jam nuts may be adjusted in order to tighten a compression force upon the rotating conduit 12 and associated rotating brake pad(s) 22, 24. Such an adjustment will increase the drag or frictional force upon the pads 22, 24, thereby slowing rotating of the rotating conduit 12, rotating outlet 20, and associated fluid spray pattern.

FIG. 3 depicts an embodiment of the present disclosure where two adjustment means or lock nuts 27a, 27b are provided. A first lock nut 27a is provided to apply a compressive force to the rotating conduit 12. Rotation and translation of the first lock nut 27a thus dictates the amount of compressive force and resultant braking force applied to the rotation of the conduit 12 and associated outlet 20. Second lock nut 27b provides means for securing the position of the first lock nut 27a and eliminate or minimize the risk of the first lock nut 27a becoming loose and/or translating (e.g. as a result of movement of the device, vibrations, etc.). Second nut 27b may be considered a secondary lock nut or a jam nut for securing the position of the first lock nut 27a.

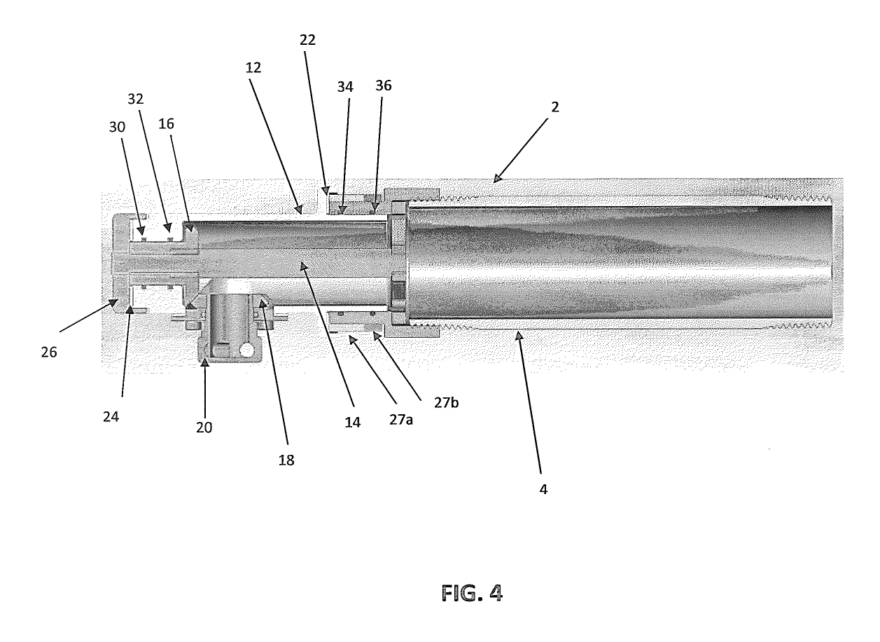

FIG. 4 provides a cross-sectional view of one embodiment of a nozzle 2 comprising features of the present disclosure. The device 2 comprises two brake elements 22, 24 disposed between a fixed end cap 26 and an inlet portion 4. Brake elements 22, 24 are disposed generally coaxially with the rotating conduit 12, and provide a frictional braking force on the conduit 12, at least when the device is provided in a position of use. Tightening means 27, which include but are not limited to one or more translatable lock nuts, allow a user to selectively adjust a compressive force upon brake elements 22, 24 and thereby adjust the braking force applied by the brake elements 22, 24 upon the rotating conduit 12. Selective rotation of the tightening means 27, which are preferably threaded onto the nozzle 2, translate tightening means 27 right-to-left as shown in FIG. 4 and provides a compressive force upon first brake element 22 and a shoulder portion of the rotating conduit 12. A similar compressive force will also be provided on a second brake element 24 which is bounded by the fixed cap 26 on at least one surface, thus increase the frictional braking force applied to the rotating conduit 12 in accordance with the general equation F_{f}=μF_{N}. As will be recognized, F_{f} is the frictional force, which is defined by the normal force (F_{N}) applied to the brake element multiplied by the coefficient of friction (μ), which is generally dependent upon the specific material of the brake element. Accordingly, for any given brake element, the frictional force or braking force is directly varied by increasing or decreasing the normal force by selective rotation of the tightening means 27. At least one o-ring or gasket 30 is provided to create a sealed element. Preferably, a plurality of o-rings 30, 32, 34, 36 are provided to create a sealed space within the rotating conduit 12, without substantially inhibiting rotation of the conduit 12.

The device 2 further comprises a rotating outlet 20 provided in combination with the rotating conduit 12. The outlet 20 rotates with rotating conduit 12, as outlet gear 18 walks along stationary gear 16 due to a force exerted upon the nozzle outlet 20 and conduit 12 based on a pressurized fluid exiting the outlet 20.

In one embodiment, a spring is provided for providing a constant spring force upon a brake element and related components. For example, in one such embodiment, a coil spring is provided between tightening means 27 and a brake element 22. The spring force applied is adjusted by rotation of the tightening means 27 to compress or expand the spring and thereby vary the braking force applied.

The coil spring or compression spring provided in combination with tightening means 27 provides for a finer adjustment of braking force, at least when compared with the direct application of force between an adjustment means 27, a brake element 22, and a conduit 12.

While FIGS. 1-4 depict one embodiment of a rotational nozzle in accordance with the present disclosure, it will be expressly recognized that the present invention is not limited to a particular arrangement. Indeed, various features and devices as shown and described herein may be provided with nozzle and rotatable impingement cleaning devices of various different constructions. Specifically, braking features and elements of the present disclosure are contemplated as being provided in any number of rotatable nozzle devices.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An apparatus for cleaning the interior of a vessel by ejecting a stream of fluid, comprising:
a) a first fluid inlet for receiving said fluid;
b) a rotatable housing mounted for rotation about a first axis;
c) a nozzle having a first fluid outlet for ejecting said fluid received by said first fluid inlet, said nozzle rotatably mounted on said rotatable housing so that said nozzle rotates about an axis, a first fluid passage placing said first fluid inlet in fluid flow communication with said first fluid outlet;
d) a beveled gear system for transferring rotation from the first fluid outlet to the rotatable housing; and
e) braking means for selectively limiting a rotational speed of said fluid outlet and said rotatable housing.

2. The apparatus of claim 1, wherein the beveled gear system comprises a first fixed gear and a second gear, said first fixed gear fixed relative to the rotatable housing and said second gear interconnected to said nozzle.

3. The apparatus of claim 2, wherein said first fixed gear and said second gear comprise a different number of gear teeth.

4. The apparatus of claim 1, wherein said braking means comprise a first brake pad and a second brake pad, said first brake pad and said second brake pad provided in force transmitting communication with said rotatable housing.

5. The apparatus of claim 1, wherein said first axis is substantially perpendicular to said axis about which said nozzle rotates.

6. The apparatus of claim 1, wherein said braking means comprises a selectively adjustable lock nut for selectively increasing and decreasing a compressive force applied to a coil spring, said coil spring applying a force to at least one brake pad.

7. A nozzle assembly for discharging a fluid for cleaning containers, comprising:
a substantially cylindrical rotatable nozzle housing;
a fluid outlet for applying a first torque on the rotatable nozzle housing and thereby rotating the nozzle housing;
said substantially cylindrical rotatable nozzle housing being rotatable about a first longitudinal axis;
said fluid outlet being rotatable about a second axis, said second axis being substantially perpendicular to said first longitudinal axis;
said fluid outlet being formed with at least one spray discharge orifice for discharging a fluid in a radial direction, said radial direction being substantially perpendicular to said second axis regardless of the rotational position of said fluid outlet.

8. The nozzle assembly of claim 7, further comprising at least one brake pad provided in force transmitting communication with said rotatable nozzle housing.

9. The nozzle assembly of claim 8, further comprising a selectively adjustable rotatable locking element for selectively increasing and decreasing a compressive force applied to said at least one brake pad.

10. The nozzle assembly of claim 7, further comprising a first brake pad provided upstream of said fluid outlet and a second brake pad provided downstream of said fluid outlet, said first and second brake pads provided in frictional engagement with said rotatable nozzle housing.

11. An apparatus for ejecting a rotating stream of fluid, comprising:
first and second ends;
an inlet formed in said first end for receiving said fluid;
a gear train comprising a first fixed gear and a second rotatable gear;
a rotatable housing disposed between said first and second ends and mounted for rotation about a first axis;
a first fixed gear mounted in said rotatable housing for driving said rotation of said rotatable housing about said first axis;
a shaft disposed substantially coaxially with said rotatable housing and said first fixed gear, said shaft provided in fixed communication with said first fixed gear;
a nozzle for ejecting said fluid, said nozzle rotatably mounted on said rotatable housing and rotatable about a second axis, said second axis disposed between said first and second ends and being substantially perpendicular to said first axis;
said nozzle interconnected with said second rotatable gear, said second rotatable gear in force transmitting communication with said first fixed gear;
a flow path directing said fluid from said inlet to said nozzle by directing said fluid to flow around said gear train, said gear train disposed between said inlet and said second end.

12. The apparatus of claim 11, wherein said first fixed gear and said second rotatable gear comprise a different number of gear teeth.

13. The apparatus of claim 11, further comprising at least one brake pad in force transmitting communication with said rotatable housing.

14. The apparatus of claim 11, further comprising a first brake pad in force transmitting communication with said rotatable housing and positioned proximal to a first end of said rotatable housing; and
a second brake pad in force transmitting communication with said rotatable housing and positioned proximal to a second end of said rotatable housing.

15. The apparatus of claim 11, further comprising braking means comprising a selectively adjustable lock nut for selectively increasing and decreasing a compressive force applied to at least one brake pad.
